(19) United States
(12) Patent Application Publication
(10) Pub. No.: US 2010/0228929 A1
(43) Pub. Date: Sep. 9, 2010

(54) EXPEDITED COMPLETION OF A TRANSACTION IN STM

(75) Inventors: David L. Detlefs, Issaquah, WA (US); Yosseff Levanoni, Redmond, WA (US); Weirong Zhu, Kirkland, WA (US); Dana Groff, Sammamish, WA (US); Alexander Dadiomov, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/400,209

(22) Filed: Mar. 9, 2009

(51) Int. Cl. G06F 12/02

(52) U.S. Cl. 711/154; 711/E12.002

(57) ABSTRACT

A software transactional memory system is provided that provides privatization safety. The system identifies situations where the completion of a transaction may be expedited because a privatization artifact will not occur. The system determines whether a privatization artifact may occur using a read and write set intersection test, transactional variables, pessimistic locks, or declared privatizing transactions. If a privatization artifact will not occur for a transaction, then the system may allow the transaction to complete prior to one or more earlier transactions.

### BACKGROUND

Computer programs may be written to allow different portions (e.g., threads) of the program to be executed concurrently. In order to execute different portions of the program concurrently, the computer system or the program typically includes some mechanism to manage the memory accesses of the different portions to ensure that the parts access common memory locations in the desired order.

Transactional memory systems allow programmers to designate transactions in a program that may be executed as if the transactions are executing in isolation (i.e., independently of other transactions and other sequences of instructions in the program). Transactional memory systems manage the memory accesses of transactions by executing the transactions in such a way that the effects of the transaction may be rolled back or undone if two or more transactions attempt to access the same memory location in a conflicting manner. Transactional memory systems may be implemented using hardware and/or software components.

Many software transactional memory (STM) systems allow programmers to include both transactional and non-transactional code in their programs. In order to be practically efficient and pay-for-play, STM systems may provide weak atomicity where no general guarantee is made for interaction between transactional and non-transactional code. However, some commonly used code idioms, such as privatization, may behave incorrectly in STM systems with weak atomicity if privatization safety is not provided. Privatization safety, however, may introduce at least some cost or overhead that may impact the parallel scalability of STM systems.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

A software transactional memory system is provided that provides privatization safety. The system identifies situations where the completion of a transaction may be expedited because a privatization artifact will not occur. The system determines whether a privatization artifact may occur using a read and write set intersection test, transactional variables, pessimistic locks, or declared privatizing transactions. If a privatization artifact will not occur for a transaction, then the system may allow the transaction to complete prior to one or more earlier transactions.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a block diagram illustrating an embodiment of a software transactional memory system.

FIG. 2 is a block diagram illustrating an embodiment of threads accessing an object.

FIG. 3 is a flow chart illustrating an embodiment of a method for expediting the completion of a transaction.

FIGS. 4A-4C are block diagrams illustrating an embodiment of expediting the completion of transactions using a read and write set intersection test.

FIGS. 5A-5C are block diagrams illustrating embodiments of expediting the completion of transactions using transactional variables.

FIGS. 6A-6B are block diagrams illustrating embodiments of expediting the completion of transactions using pessimistic locks.

FIG. 7 is a block diagram illustrating an embodiment of a expediting the completion of transactions using declared privatizing transactions.

FIG. 8 is a block diagram illustrating an embodiment of a compiler system with a compiler that is configured to compile source code with software transactional memory transactions.

FIG. 9 is a block diagram illustrating an embodiment of a computer system configured to implement a software transactional memory system.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

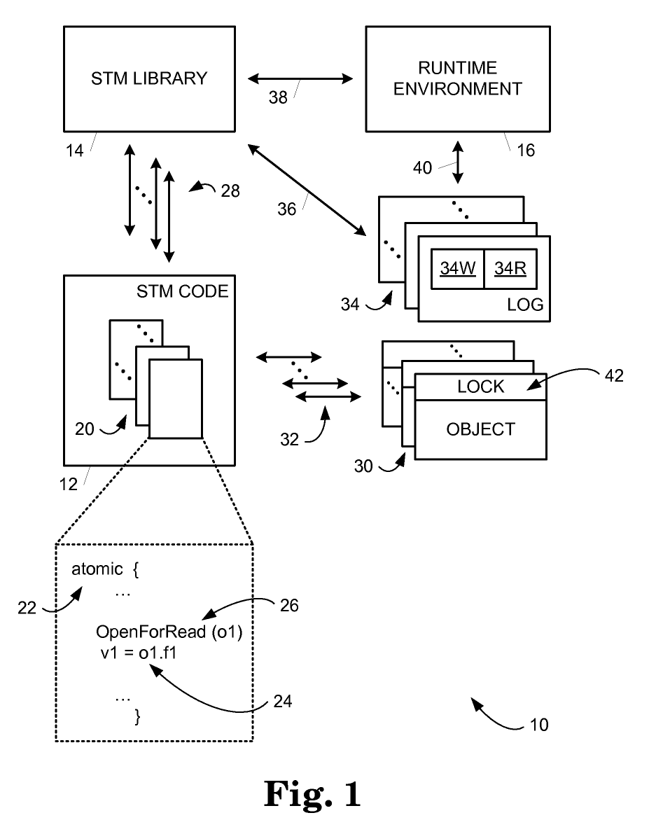

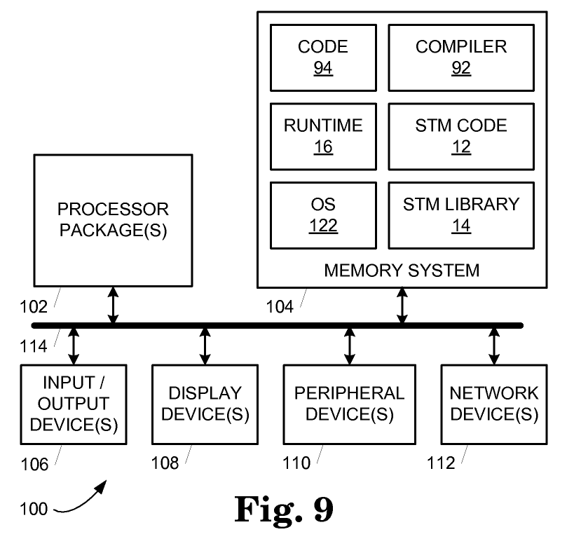

FIG. 1 is a block diagram illustrating an embodiment of a software transactional memory (STM) system 10. STM system 10 represents a runtime mode of operation in a computer system, such as computer system 100 shown in FIG. 9 and described in additional detail below, where the computer system is executing instructions to run STM code 12.

STM system 10 includes STM code 12, an STM library 14, and a runtime environment 16. STM system 10 is configured to manage the execution of STM transactions 20 that form atomic blocks in STM code 12 to allow transactions 20 to be executed atomically and, if desired, rollback or undo changes made by transactions 20. To do so, STM system 10 tracks memory accesses by transactions 20 to objects 30 using a log 34 for each executing transaction 20.

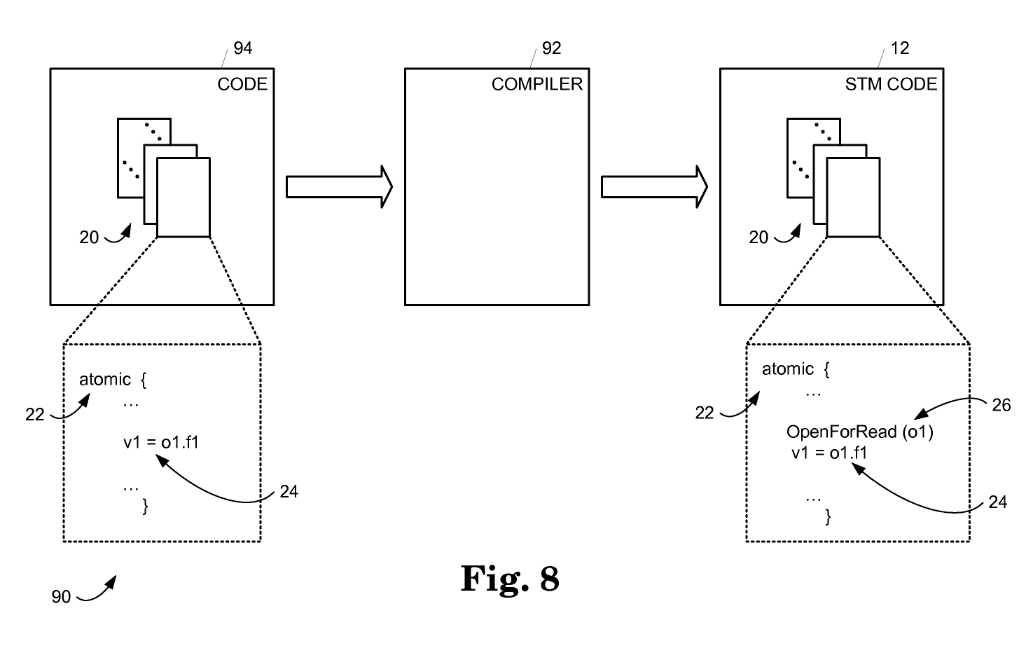

STM code 12 includes a set of one or more transactions 20. Each transaction 20 includes a sequence of instructions that is designed to execute atomically, i.e., as if the sequence is executing in isolation from other transactional and non-transactional code in STM code 12. Each transaction 20 includes an atomic block designator 22 that indicates that a corresponding portion of STM code 12 is a transaction 20. Each transaction 20 also includes zero or more memory accesses 24 that read from and/or write to one or more objects 30 as indicated by arrows 32. Transactions 20 also include invocations 26 of STM primitives, which may be added by a compiler such as a compiler 92 shown in FIGS. 8 and 9 and described in additional detail below, that call functions in STM library 14. The STM primitives of STM library 14 return results to transactions 20 as indicated by function calls and returns 28.

STM library 14 includes STM primitives and instructions executable by the computer system in conjunction with runtime environment 16 to implement STM system 10. The STM primitives of STM library 14 that are callable by transactions 20 include management primitives that implement start, commit, abort, and retry functions in STM library 14. A transaction 20 calls the start function to initiate the management of the transaction 20 by STM library 14. A transaction 20 calls the commit function to finalize the results of the transaction 20 in memory system 204, if successful. A transaction 20 calls the abort function to roll back or undo the results of the transaction 20 in memory system 204. A transaction 20 calls the retry function to retry the transaction 20. In other embodiments, some or all of the functions performed by STM library may be included in runtime environment 16 or added to transactions 20 by a compiler such as compiler 92 shown in FIG. 8.

The STM primitives of STM library 14 that are callable by transactions 20 also include memory access primitives that manage accesses to objects 30 that are written and/or read by a transaction 20. The memory access primitives access a set of one or more transactional locks 42 for each object 30. In one embodiment, STM system 10 uses the object header of objects 30 to store the corresponding transactional locks 42. Each transactional lock 42 indicates whether a corresponding object 30 or portion of a corresponding object 30 is locked or unlocked for writing and/or reading. When an object 30 is locked for writing, the corresponding transactional lock 42 includes an address or other reference that locates an entry for the object 30 in a write log 34W in one embodiment. When an object 30 is not locked for writing, the corresponding transactional lock 42 includes a version number of the object 30.

For each non-array object 30, the memory access primitives may access a single transactional lock 42 that locks or unlocks the non-array object 30 for writing and/or reading. For each array object 30, the memory access primitives may access a set of one or more transactional lock 42 where each transaction lock 42 in the set locks or unlocks a corresponding portion of the array object 30 for writing and/or reading. Runtime environment 16 creates and manages the transactional lock(s) 42 for each object 30.

The memory access primitives of STM library 14 generate and manage a set of one or more STM logs 34 for each transaction currently being executed. Each set of STM logs 34 includes a write log 34W and a read log 34R in one embodiment. Each write log 34W includes an entry for each object 30 that is written by a transaction 20 where each entry includes an address of a corresponding object 30, the version number from the transactional lock 42 of the corresponding object 30, and an address or other reference that locates a shadow copy of the corresponding object 30. Each read log 34R includes an entry for each object 30 that is read by a transaction 20 where each entry includes a reference that locates the transactional lock 42 of a corresponding object 30.

Runtime environment 16 may be any suitable combination of runtime libraries, a virtual machine (VM), an operating system (OS) functions, such as functions provided by an OS 122 shown in FIG. 9 and described in additional detail below, and/or compiler functions, such as functions provided by compiler 92 shown in FIGS. 8 and 9 and described in additional detail below.

STM library 14 performs the following algorithm, or variations thereof, to execute each transaction 20. Each time a transaction 20 is started by a thread of execution, STM library 14 creates and initializes variables used to manage the transaction. STM library 14 then allows the transaction 20 to execute and perform any write and/or read memory accesses to objects 30 as follows.

To access an object 30 for writing, the transaction 20 invokes a memory access primitive that opens the object 30 for writing. STM library 14 acquires a transactional lock 42 corresponding to the object 30 for the transaction 20 if the lock is available. If the object 30 is not available (i.e., the object 30 is locked by another transaction 20), then STM library 14 detects a memory access conflict between the current transaction 20 and the other transaction 20 and may rollback and re-execute the current transaction 20. If the object 30 is locked by the current transaction 20, then STM library 14 has already acquired the transactional lock 42 corresponding to the object 30 for the transaction 20. Once a corresponding transaction lock 42 is acquired, STM library 14 causes each write access 32 to be made to either the object 30 itself or a shadow copy of a corresponding object 30 (not shown) and causes an entry corresponding to the write access 32 to be stored in log 34W. For non-array objects 30, the shadow copy, if used, may be stored in log 34W. For array objects 30, a shared shadow copy, if used, may be stored separately from log 34W.

To access an object 30 for reading, the transaction 20 invokes a memory access primitive that opens the object 30 for reading. If the object 30 is not write locked and does not exceed the maximum number of pessimistic readers supported by the pessimistic read lock, STM library 14 causes an entry corresponding to the read access to be stored in read log 34R. If the read access is a pessimistic read access, STM library 14 also acquires a transactional lock 42 for the object 30. If the object 30 is locked by another transaction 20, then STM library 14 detects a memory access conflict between the current transaction 20 and the other transaction 20 and may rollback and re-execute the current transaction 20. If the object 30 is locked by the current transaction 20, then STM library 14 may cause an entry corresponding to the read access to be stored in read log 34R or set a flag corresponding to the object 30 in write log 34W to indicate that the object 30 was also read. STM library 14 causes a read access 32 that occurs before a designated object 30 has been opened from writing by the transaction 20 to be made directly from the corresponding object 30. STM library 14 causes each read access 32 that occurs after a designated object 30 has been opened for writing by a transaction 20 to be made from either the corresponding object 30 directly or the corresponding shadow copy.

Subsequent to performing the memory accesses, STM library 14 allows the transaction 20 to begin commit processing to ensure that the memory accesses by the transaction 20 did not conflict with the memory accesses by any other transaction 20. The commit processing may include validating the read accesses of the transaction 20, updating any objects 30 that were modified by the transaction 20 with the shadow copies used to store the modifications, and/or storing an updated version number in any objects 30 that were modified by the transaction 20. If STM library 14 detects any memory access conflicts between the current transaction 20 and another transaction 20 during the commit processing, STM library 14 may rollback and re-execute the current transaction 20. Subsequent to performing the commit processing, STM library 14 allows the transaction 20 to complete subject to a completion order of transactions 20 as described in additional detail below. After a transaction 20 completes, STM library 14 allows the thread that caused the transaction 20 to be executed to resume and execute additional transactional or non-transactional code.

In one embodiment, STM system 10 provides weak atomicity between transactional code (i.e., transactions 20) and non-transactional code in STM code 12. With weak atomicity, STM system 10 does not provide any general guarantees for interactions between transactional and non-transactional code when STM code 12 is executed. Without any guarantees for interactions between transactional and non-transactional code, an incorrect code behavior that creates a privatization artifact may occur in weak atomicity STM systems that do not provide privatization safety.

STM code 12 may include a programming idiom known as privatization. With privatization, STM code 12 stores a reference to an object 30 in a global data structure (not shown) and maintains a convention that the object 30 is only accessible via the reference stored in the shared data structure in one embodiment. If a thread of STM code 12 removes the object 30 from the shared data structure, the thread has exclusive access to the object 30 and can access and modify it without synchronizing the access or modifications with other threads. In another privatization embodiment, STM code 12 stores a global Boolean flag to indicate whether an object 30 is privatized or not. A thread of STM code 12 privatizes an object 30 by setting the flag and other threads detect that the object 30 is privatized by checking the flag. In further privatization embodiment, STM code 12 stores a global reference to indicate whether an object 30 is privatized or not. A thread of STM code 12 privatizes an object 30 by copying the global reference and setting the global reference to null. Other threads detect that an object 30 is privatized if the global reference of the object 30 is null.

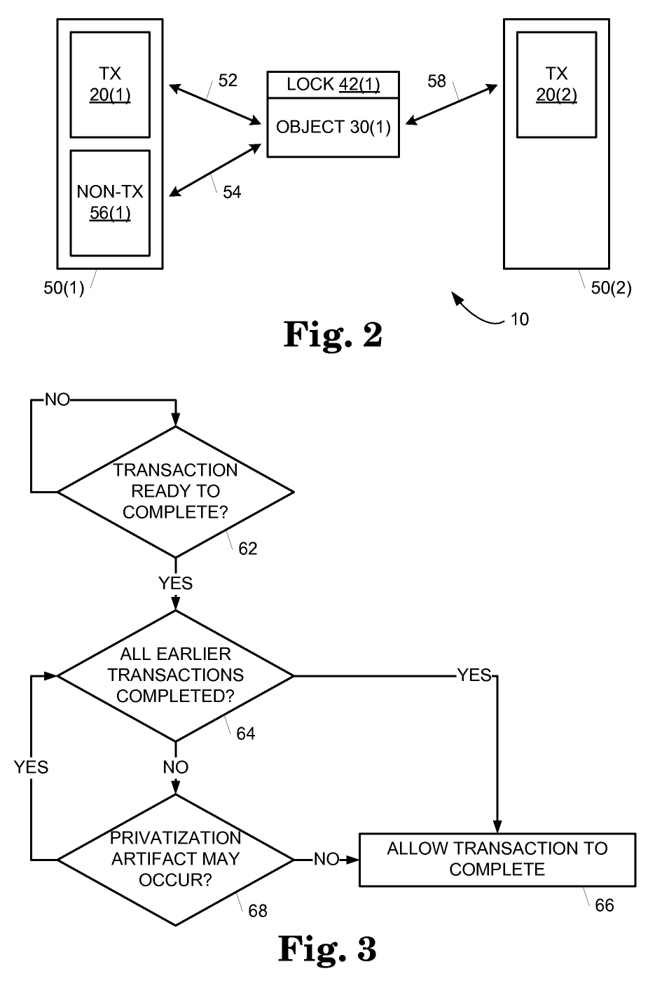

If weakly atomic embodiments of STM system 10 did not provide privatization safety, a privatization artifact may occur as shown in the example of FIG. 2. In FIG. 2, a thread 50(1) causes a transaction 20(1) to be executed by STM system 10 and another thread 50(2) causes another transaction 20(2) to be executed concurrently by STM system 10. Transaction 20(1) may privatize an object 30(1) as indicated by an arrow 52, and non-transactional code 56(1) in the same thread 50(1) may later access and modify the object 30(1) as indicated by an arrow 54. If transaction 20(2), or any other concurrently executing transaction 20 (not shown), accesses and modifies object 30(1) after object 30(1) has been privatized by thread 50(1), then non-transactional code 56(1) in thread 50(1) may access an incorrect value of object 30(1) (i.e., the value stored by thread 50(2)). This incorrect value is referred to as a privatization artifact.

STM system 10 may provide privatization safety by ensuring that privatizing transactions 20 (e.g., transaction 20(1)) wait (i.e., quiesce) until all concurrently executing transactions 20 in other threads (e.g., transaction 20(2)) that may be damaging transactions have completed before allowing the privatizing transactions 20 to complete. Damaging transactions are those transactions 20 that may perform a damaging write to a privatized object 30 and thereby create a privatization artifact. For example, STM system 10 may serialize the commit processing of transactions 20 using a commit ticket and prevent any given transaction 20 from completing until all transactions 20 that begin commit processing prior to the given transaction 20 have completed in embodiments that use shadows copies for write accesses (i.e., buffered write embodiments). This quiescence implementation, however, may inhibit parallel scalability by causing threads that have completed a transaction 20 to wait for other transactions 20 to complete because of the possibility that the transaction 20 may have privatized an object 30 and one or more of the concurrently executing transactions 20 may be a damaging transaction 20. As another example, STM system 10 may serialize the commit processing of transactions 20 to prevent any given transaction 20 from completing until all transactions 20 that began executing prior to the given transaction 20 have completed in embodiments that perform write accesses directly to objects 30 (i.e., in-place write embodiments).

To enhance parallel scalability, STM system 10 identifies situations where a privatization artifact will not occur between a given transaction 20 that is ready to complete and one or more earlier transactions 20 in a completion order. As used herein, the term earlier transaction in a completion order refers to a transaction 20 that is scheduled by STM system 10 to complete prior to a given transaction 20. Likewise, the term later transaction in a completion order refers to a transaction 20 that is scheduled by STM system 10 to complete subsequent to a given transaction 20. In situations where STM system 10 can ensure that a privatization artifact will not occur for a given transaction 20, STM system 10 allows the given transaction 20 to complete prior to one or more earlier transactions 20 in the completion order.

STM system 10 effectively alters the completion order of transactions 20 in situations where a privatization artifact will not occur between a transaction 20 that is ready to complete and one or more earlier transactions 20. In buffered write embodiments, STM system 10 may determine an initial completion order of transactions 20 based on the order that the transactions 20 began commit processing. In in-place write embodiments, STM system 10 may determine an initial completion order of transactions 20 based on the order that the transactions 20 began executing. In other embodiments, STM system 10 may determine an initial completion order of transactions 20 based on other criteria.

STM system 10 uses the initial completion order as an actual completion order of transactions 20 unless STM system 10 can determine that a privatization artifact will not occur. If STM system 10 makes such a determination between a current transaction 20 and one or more earlier transactions 20, then STM system 10 implements a completion order that differs from the initial completion order by moving the current transaction 20 before the one or more earlier transactions 20 that, in conjunction with the current transaction 20, will not produce a privatization artifact.

FIG. 3 is a flow chart illustrating an embodiment of a method for expediting the completion of a current transaction 20 performed by STM library 14. In FIG. 3, STM library 14 determines whether a current transaction is ready to complete as indicated in a block 62. A current transaction 20 is generally ready to complete in response to finishing commit processing, as described above, which may include validating read accesses, releasing write locks, and/or storing shadow copies, if used, to objects 30.

If the current transaction 20 is ready to complete, then STM library 14 determines whether all earlier transactions 20 in the completion order have completed as indicated in a block 64. If all earlier transactions 20 in the completion order have completed, then STM library 14 allows the current transaction 20 to complete as indicated in a block 66. Because all earlier transactions 20 have completed in this case, the completion of the current transaction 20 will not cause a privatization artifact as long as no later transaction 20 (i.e., a transaction 20 that is scheduled to complete subsequent to the current transactions 20 in the completion order) that privatizes an object 30 is allowed to complete prior to the current transaction 20.

If one or more earlier transactions 20 in the completion order have not completed, then STM library 14 determines whether a privatization artifact may occur as indicated in a block 68. If STM library 14 ensures that a privatization artifact will not occur between the current transactions 20 and the earlier transaction or transactions 20, then STM library 14 allows the current transaction 20 to complete as indicated in block 66. By doing so, STM library 14 expedites the completion of the current transaction 20 by allowing the current transaction 20 to complete prior to one or more earlier transactions 20 in the completion order.

If STM library 14 cannot conclusively ensure that a privatization artifact will not occur between the current transactions 20 and the earlier transaction or transactions 20, then STM library 14 assumes that a privatization artifact may occur and repeats the functions of blocks 64 and 68 until all earlier transactions 20 have completed as determined in block 64 or until STM library 14 can conclusively determine that a privatization artifact will not occur between the current transaction 20 and the earlier transactions 20 that have not completed as determined in block 68.

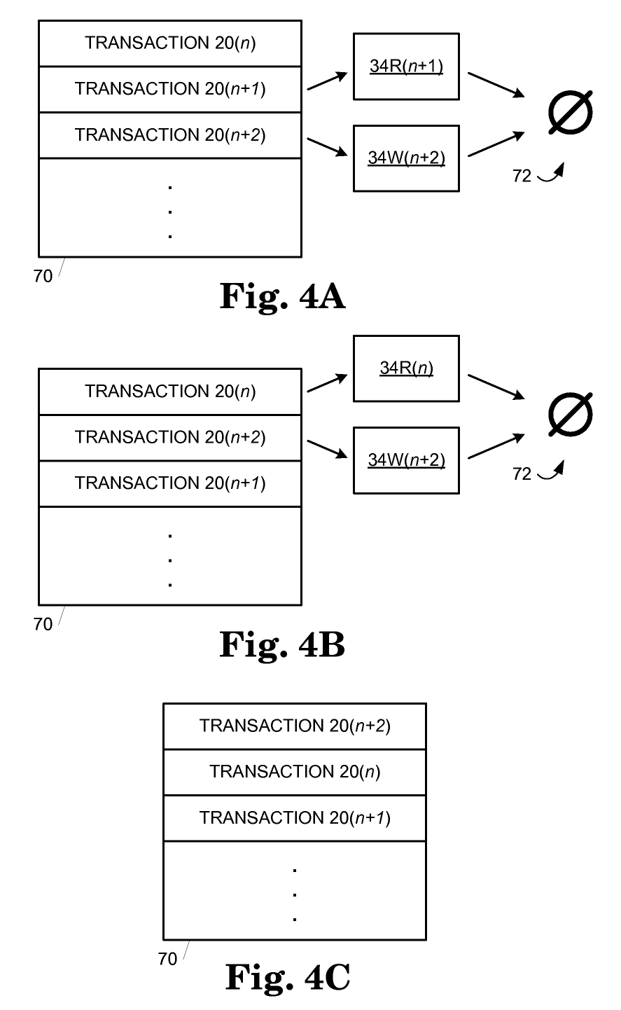

STM library 14 determines whether a privatization artifact may occur using one or more of the embodiments described with reference to FIGS. 4A-4C, 5A-5C, 6A-6B, and 7.

FIGS. 4A-4C are block diagrams illustrating an embodiment of expediting the completion of transactions 20 using a read and write set intersection test. As shown in FIG. 4A, STM library 14 maintains a queue 70 of transactions 20 with write accesses in this embodiment. STM library 14 adds each transaction 20 with write accesses to queue 70 according to a completion order criteria. Thus, queue 70 forms a completion order of transactions 20. STM library 14 allows transactions 20 with no write accesses (i.e., read-only transactions 20) to complete without being added to queue 70.

In the embodiment of FIGS. 4A-4C, STM library 14 assumes that each transaction 20 is a possible privatizing transaction 20. With this assumption, STM library 14 allows a later transaction 20 in queue 70 to complete prior to an earlier transaction 20 in queue 70 only if the earlier transaction 20 is not a damaging transaction. To do so, STM library 14 determines whether the earlier transaction 20 reads any of a set of objects 30 that may have been privatized by the later transaction 20. STM library 14 performs a write and read set intersection test between the later transaction 20 and each earlier transaction 20 (i.e., each possibly damaging transaction) to determine whether the intersection is an empty set. If so, then none of the earlier transactions 20 are a damaging transaction. As a result, STM library 14 ensures that a privatization artifact will not occur and may allow the possible privatizing transaction 20 to complete before the earlier transaction or transactions 20 regardless of whether the possible privatizing transaction 20 actually privatizes any data or not. If one of the earlier transactions 20 may be a damaging transaction, then STM library 14 prevents the possible privatizing transaction 20 from completing before the earlier transaction 20 because of the possibility that a privatization artifact may be created.

In example of FIG. 4A, queue 70 includes transactions 20(n), 20(n+1), 20(n+2), and so on where transaction 20(n) is earlier than transaction 20(n+1) in the completion order and transaction 20(n+1) is earlier than transaction 20(n+2) in the completion order and so on. STM library 14 determines whether an intersection between read log 34R(n+1) (i.e., the read set of transaction 20(n+1)) and write log 34W(n+2) (i.e., the write set of transaction 20(n+2)) is an empty set 72. If so, then STM library 14 allows transaction 20(n+2) to complete prior to the earlier transaction 20(n+1) by moving transaction 20(n+2) ahead of transaction 20(n+1) in queue 70 as shown in FIG. 4B. If not, then STM library 14 does not allow transaction 20(n+2) to complete prior to the earlier transaction 20(n+1) by leaving transaction 20(n+2) behind transaction 20(n+1) in queue 70 as shown in FIG. 4A.

Because transaction 20(n+2) is not at the top of queue 70 in the example of FIG. 4B, STM library 14 also determines whether an intersection between read log 34R(n) (i.e., the read set of transaction 20(n)) and write log 34W(n+2) is an empty set 72. Again, STM library 14 moves transaction 20(n+2) ahead of transaction 20(n) in queue 70 as shown in FIG. 4C if so to allow transaction 20(n+2) to complete prior to transaction 20(n). If not, STM library 14 leaves transaction 20(n+2) behind transaction 20(n) in queue 70 as shown in FIG. 4A.

By reordering queue 70 in the embodiment of FIGS. 4A-4C as described above, STM library 14 implements a completion order that differs from an initial completion order where an earlier transaction 20 does not read any of a set of objects 30 that may be privatized by a later transaction 20.

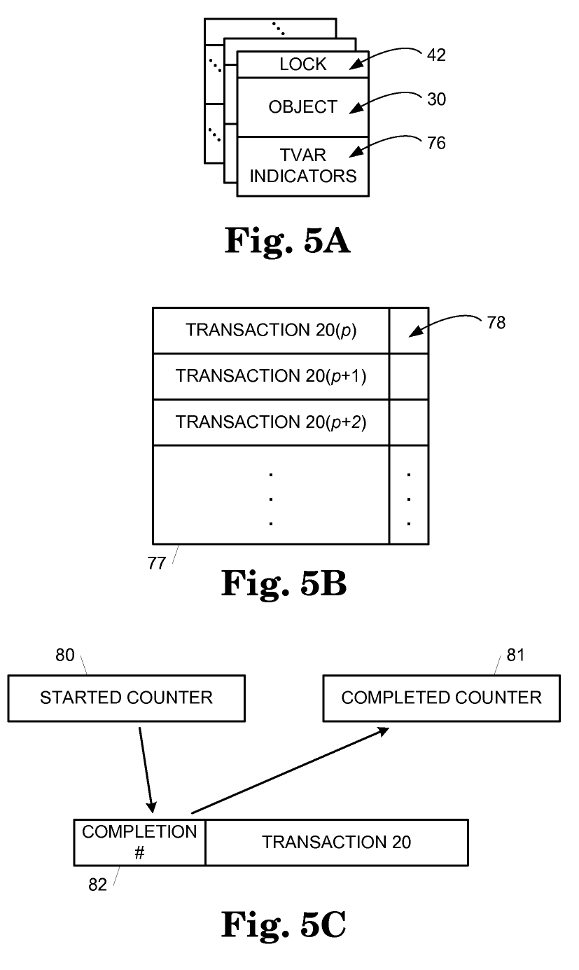

FIGS. 5A-5C are block diagrams illustrating embodiments of expediting the completion of transactions using transactional variables (TVARs). In this embodiment, STM library 14 stores one or more TVAR indicators 76 for each object 30 that indicates that one or more corresponding fields in each object 30 will be used only by transactions 20 in STM code 12 and not by any non-transactional code in STM code 12. In addition, STM library 14 identifies transactions 20 that access only TVARs. A transaction 20 that only writes to TVARs is referred to as a TVAR transaction 20. Each TVAR transaction 20 may include an indication that is detectable by STM library 14 to identify the transaction 20 as a TVAR transaction 20. STM library 14 may also identify a TVAR transaction 20 dynamically by determining whether a transaction 20 writes any non-TVARs.

The problematic privatization case involves a concurrent modification to a privatized object 30 by a damaging transaction while the object 30 is being accessed by non-transactional code that follows a privatizing transaction 20 in a privatizing thread. Because a TVAR can only be accessed by transactions 20, any privatized object 30 that is accessed by non-transactional code cannot be a TVAR. Thus, no TVAR transaction 20 can be a damaging transaction.

Like the embodiment of FIGS. 4A-4C, STM library 14 assumes that each transaction 20 is a possible privatizing transaction 20 and allows a later transaction 20 to complete prior to an earlier transaction 20 only if the earlier transaction 20 is not a damaging transaction. Accordingly, STM library 14 allows any later transaction 20 to complete prior to any earlier TVAR transaction 20 because TVAR transactions 20 cannot be damaging transactions. STM library 14 ensures that a privatization artifact will not occur by determining that a transaction 20 is a TVAR transaction 20 (i.e., a transaction 20 that only writes TVARs) in this embodiment. Likewise, any earlier transaction 20 that is not a TVAR transaction 20 may be a damaging transaction, and STM library 14 prevents a later transaction 20 from completing before any non-TVAR transactions 20 (i.e., a transaction 20 that accesses any non-TVARs).

In one embodiment with TVAR transactions 20 shown in FIG. 5B, STM library 14 maintains a queue 77 (or other suitable data structure) of transactions 20. STM library 14 adds each transaction 20 to queue 77 according to a completion order criteria so that queue 77 forms a completion order of transactions 20. STM library 14 also stores a TVAR transaction indicator 78 with each transaction 20 that identifies whether a corresponding transaction 20 is a TVAR transaction 20 or a non-TVAR transaction 20. Using TVAR transaction indicators 78, STM library 14 allows any later transaction 20 in queue 77 to complete prior to one or more earlier TVAR transactions 20 but not prior to any non-TVAR transactions 20.

In another embodiment with TVAR transactions 20 shown in FIG. 5C, STM library 14 maintains a commit processing started counter 80 and a commit processing completed counter 81 to track the number of non-TVAR transactions 20 that have began commit processing and the number of non-TVAR transactions 20 that have completed, respectively. STM library 14 assigns completion numbers 82 to transactions 20 when transactions 20 begin commit processing. The completion number 82 is equal to the value of started counter 80 when a transaction 20 starts commit processing. STM library 14 atomically increments started counter 80 each time that a completion number 82 is assigned to a non-TVAR transaction 20 and leaves started counter 80 unchanged (i.e., does not increment started counter 80) each time that a completion number 82 is assigned to a TVAR transaction 20. STM library 14 increments completed counter 81 each time that a non-TVAR transaction 20 completes but does not increment completed counter 81 when any TVAR transactions 20 completes.

STM library 14 allows a transaction 20 to complete only when the completion number 82 of the transaction 20 is equal to completed counter 81. Any TVAR transactions 20 that begin commit processing after a given non-TVAR transaction 20 but before a next non-TVAR transaction 20 will be assigned the same completion number 82 by STM library 14. As a result, these TVAR transactions 20 can complete in any order when they are ready once completed counter 81 becomes equal to the completion number 82 of the TVAR transactions 20. In addition, the next non-TVAR transaction 20 will be assigned the same completion number 82 as any TVAR transactions 20 that begin commit processing after the previous non-TVAR transaction 20. Thus, the next non-TVAR transaction 20 can complete in any order with any TVAR transactions 20 that begin commit processing after the previous non-TVAR transaction 20.

With the embodiment of FIG. 5C, STM library 14 allows any later transaction 20 to complete prior to any earlier TVAR transaction 20 but prevents all later TVAR and non-TVAR transactions 20 from completing prior to any earlier non-TVAR transaction 20. As a result, STM library 14 may implement a completion order that differs from an initial completion order that may otherwise be determined from the order that transactions 20 began commit processing or from another suitable completion order criteria while ensuring that privatization artifacts will not occur.

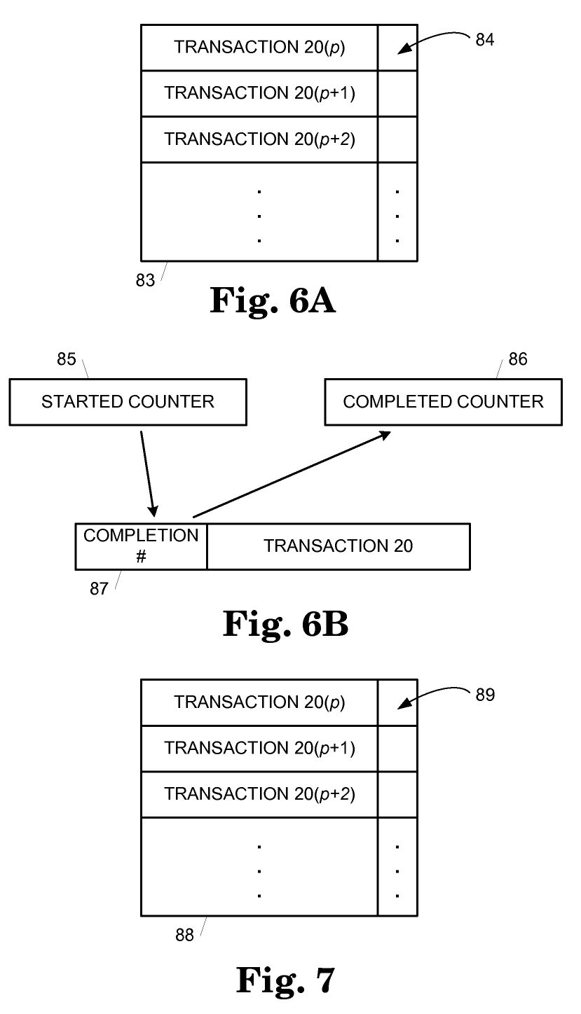

FIGS. 6A-6B are block diagrams illustrating embodiments of expediting the completion of transactions using pessimistic locks. STM library 14 treats transactions 20 with only pessimistic read and write accesses (i.e., accesses that use locks 42 as pessimistic locks) similar to TVAR transactions as described above with reference to FIGS. 5B and 5C. Transactions 20 that use pessimistic locks for all read and write accesses are referred to as pessimistic transactions 20. Pessimistic transactions 20 cannot be damaging transactions. STM library 14 ensures that a privatization artifact will not occur by determining that a transaction 20 is a pessimistic transaction 20 in this embodiment. Accordingly, STM library 14 allows any later transaction 20 to complete prior to any earlier pessimistic transactions 20 and prevents a later transaction 20 from completing before any non-pessimistic transactions 20 (i.e., a transaction 20 that uses any non-pessimistic locks).

In one embodiment with pessimistic transactions 20 shown in FIG. 6A, STM library 14 maintains a queue 83 (or other suitable data structure) of transactions 20 that forms a commit order of transactions 20 similar to the embodiment of FIG. 5B. STM library 14 also stores a pessimistic transaction indicator 84 with each transaction 20 that identifies whether a corresponding transaction 20 is a pessimistic transaction 20 or a non-pessimistic transaction 20. STM library 14 allows any later transaction 20 in queue 83 to complete prior to one or more earlier pessimistic transactions 20 but not prior to any non-pessimistic transactions 20.

In another embodiment with pessimistic transactions 20 shown in FIG. 6B, STM library 14 maintains a commit processing started counter 85 and a commit processing completed counter 86 to track the number of non-pessimistic transactions 20 that have began commit processing and the number of non-pessimistic transactions 20 that have completed, respectively. STM library 14 assigns completion numbers 87 to transactions 20 when transactions 20 begin commit processing. The completion number 87 is equal to the value of started counter 85 when a transaction 20 starts commit processing. STM library 14 atomically increments started counter 85 each time that a completion number 87 is assigned to a non-pessimistic transaction 20 and leaves started counter 85 unchanged (i.e., does not increment started counter 85) each time that a completion number 87 is assigned to a pessimistic transaction 20. STM library 14 increments completed counter 86 each time that a non-pessimistic transaction 20 completes but does not increment completed counter 86 when any pessimistic transactions 20 complete.

STM library 14 allows a transaction 20 to complete only when the completion number 87 of the transaction 20 is equal to completed counter 86. STM library 14 allows any later transaction 20 to complete prior to any earlier pessimistic transaction 20 but prevents all later pessimistic and non-pessimistic transactions 20 from completing prior to any earlier non- pessimistic transaction 20. As a result, STM library 14 may implement a completion order that differs from an initial completion order that may otherwise be determined from the order that transactions 20 began commit processing or from another suitable completion order criteria while ensuring that privatization artifacts will not occur.

The embodiments of FIGS. 6A-6B may be particularly beneficial where commit processing of some transactions 20 takes significantly more time than commit processing of other transactions 20. Transactions 20 with long commit processing times may be implemented as pessimistic transactions to allow other transactions 20 to complete without waiting for transactions 20 with long commit processing times to complete.

In other embodiments, the techniques of FIGS. 5A-5C and FIGS. 6A-6B may be combined. Because neither TVAR transactions 20 nor pessimistic transactions 20 can be damaging transactions, STM library 14 ensures that a privatization artifact will not occur by determining that a transaction 20 either a TVAR transaction 20 or a pessimistic transaction 20 in this embodiment. STM library 14 allows a later transaction 20 to complete prior to any earlier TVAR transactions 20 and pessimistic transactions 20 in these embodiments.

With the embodiment of FIG. 6A, for example, STM library 14 may use each indicator 84 to indicate whether a corresponding transaction 20 is one of a TVAR transaction 20 and a pessimistic transaction 20 or not one of a TVAR transaction 20 and a pessimistic transaction 20. STM library 14 allows any later transaction 20 in queue 83 to complete prior to one or more earlier TVAR transactions 20 and pessimistic transactions 20 but not prior to any non-TVAR transactions 20 or non-pessimistic transactions 20.

As another example using the embodiment of FIG. 6B, STM library 14 uses commit processing started counter 85 to track the combined number of non-TVAR transactions 20 and non-pessimistic transactions 20 that have began commit processing. STM library 14 also uses commit processing completed counter 86 to track the combined number of non-TVAR transactions 20 and non-pessimistic transactions 20 that have completed. STM library 14 atomically increments started counter 85 each time that a completion number 87 is assigned to a non-TVAR transaction 20 or a non-pessimistic transaction 20 and leaves started counter 85 unchanged (i.e., does not increment started counter 85) each time that a completion number 87 is assigned to a TVAR transaction 20 or a pessimistic transaction 20. STM library 14 increments completed counter 86 each time that a non-TVAR transaction 20 or a non-pessimistic transaction 20 completes but does not increment completed counter 86 when any TVAR transactions 20 or pessimistic transactions 20 complete. STM library 14 allows a transaction 20 to complete only when the completion number 87 of the transaction 20 is equal to completed counter 86.

FIG. 7 is a block diagram illustrating an embodiment of a expediting the completion of transactions using declared privatizing transactions 20. In this embodiment, any transactions 20 that privatize an object 30 include a declaration that indicates that the transaction 20 is privatizing. The declaration may be static or dynamic and may be implemented as a call to STM library 14 that is inserted after a privatizing operation in a transaction 20. STM library 14 maintains a queue 88 of transactions 20 in this embodiment. STM library 14 adds each transaction 20 to queue 88 according to a completion order criteria so that queue 88 forms a completion order of transactions 20. STM library 14 also stores a privatizing indicator 89 with each transaction 20 that identifies whether a corresponding transaction 20 is a privatizing transaction 20 or a non-privatizing transaction 20.

In the embodiment of FIG. 7, STM library 14 assumes that each transaction 20 is a possible damaging transaction. Damaging transactions in this embodiment, however, can only damage transactions 20 that have been declared to be privatizing transactions 20 as indicated by privatizing indicators 89. Accordingly, STM library 14 allows a later non-privatizing transaction 20 (i.e., a transaction 20 that is not a privatizing transaction 20) to complete prior to any earlier transactions. STM library 14 prevents any privatizing transactions 20 from completing prior to any earlier privatizing and non-privatizing transactions 20.

By reordering queue 88 in the embodiment of FIG. 7 as described above, STM library 14 implements a completion order that differs from an initial completion order where a later non-privatizing transaction 20 may complete prior to any earlier transactions 20.

FIG. 8 is a block diagram illustrating an embodiment of a compiler system 90 with a compiler 92 that is configured to compile source code 94 with STM transactions 20.

Compiler system 90 represents a compile mode of operation in a computer system, such as computer system 100 shown in FIG. 9 and described in additional detail below, where the computer system is executing instructions to compile code 94 into STM code 12. In one embodiment, compiler system 90 includes a just-in-time (JIT) compiler system that operates in the computer system in conjunction with a runtime environment executed by an operating system (OS), such as OS 122 shown in FIG. 9 and described in additional detail below, STM library 14, and any additional runtime libraries (not shown). In another embodiment, compiler system 90 includes a stand-alone compiler system that produces STM code 12 for execution on the same or a different computer system.

Code 94 includes a set of one or more STM transactions 20. Each STM transaction 20 includes an atomic block designator 22 that indicates to compiler 92 that a corresponding portion of code 94 is an STM transaction 20. Each STM transaction 20 may include zero or more memory accesses 24 that read from and/or write to an object 30. Code 94 may be any suitable source code written in a language such as Java or C# or any suitable bytecode such as Common Intermediate Language (CIL), Microsoft Intermediate Language (MSIL), or Java bytecode.

Compiler 92 accesses or otherwise receives code 94 with transactions 20 that include memory accesses 24. Compiler 92 identifies memory accesses 24 and compiles code 94 into STM code 12 with invocations 26 of STM array object primitives in STM library 14 for each memory access 24. Compiler 92 performs any desired conversion of the set of instructions of code 94 into a set of instructions that are executable by a designated computer system and includes the set of instructions in STM code 12.

FIG. 9 is a block diagram illustrating an embodiment of a computer system 100 configured to implement STM system 10.

Computer system 100 includes one or more processor packages 102, memory system 104, zero or more input/output devices 106, zero or more display devices 108, zero or more peripheral devices 110, and zero or more network devices 112. Processor packages 102, memory system 104, input/output devices 106, display devices 108, peripheral devices 110, and network devices 112 communicate using a set of interconnections 114 that includes any suitable type, number, and configuration of controllers, buses, interfaces, and/or other wired or wireless connections.

Computer system 100 represents any suitable processing device configured for a general purpose or a specific purpose. Examples of computer system 100 include a server, a personal computer, a laptop computer, a tablet computer, a personal digital assistant (PDA), a mobile telephone, and an audio/video device. The components of computer system 100 (i.e., processor packages 102, memory system 104, input/output devices 106, display devices 108, peripheral devices 110, network devices 112, and interconnections 114) may be contained in a common housing (not shown) or in any suitable number of separate housings (not shown).

Processor packages 102 each include one or more execution cores. Each execution core is configured to access and execute instructions stored in memory system 104. The instructions may include a basic input output system (BIOS) or firmware (not shown), OS 122, STM code 12, STM library 14, runtime environment 16, compiler 92, and code 94. Each execution core may execute the instructions in conjunction with or in response to information received from input/output devices 106, display devices 108, peripheral devices 110, and/or network devices 112.

Computer system 100 boots and executes OS 122. OS 122 includes instructions executable by execution cores to manage the components of computer system 100 and provide a set of functions that allow programs to access and use the components. OS 122 executes runtime environment 16 to allow STM code 12 and STM library to be executed. In one embodiment, OS 122 is the Windows operating system. In other embodiments, OS 122 is another operating system suitable for use with computer system 100.

Computer system 100 executes compiler 92 to generate STM code 12 from code 94. Compiler 92 accesses or otherwise receives code 94 and transforms code 94 into STM code 12 for execution by computer system 100. Compiler 92 performs any desired conversion of the set of instructions of code 94 into a set of instructions that are executable by computer system 100 and includes the set of instructions in STM code 12. Compiler 92 also identifies blocks 20 in code 94 from transaction designators 22 and modifies blocks 20 in STM code 12 to include invocations of STM primitives 26.

In one embodiment, compiler 92 includes a just-in-time (JIT) compiler that operates in computer system 100 in conjunction with OS 122, runtime environment 16, and STM library 14. In another embodiment, compiler 92 includes a stand-alone compiler that produces STM code 12 for execution on computer system 100 or another computer system (not shown).

Computer system 100 executes runtime environment 16 and STM library 14 to allow STM code 12, and transactions 20 therein, to be executed in computer system 100 as described above.

Memory system 104 includes any suitable type, number, and configuration of volatile or non-volatile storage devices configured to store instructions and data. The storage devices of memory system 104 represent computer readable storage media that store computer-executable instructions including STM code 12, STM library 14, runtime environment 16, OS 122, compiler 92, and code 94. The instructions are executable by computer system 100 to perform the functions and methods of STM code 12, STM library 14, runtime environment 16, OS 122, compiler 92, and code 94 as described herein. Memory system 104 stores instructions and data received from processor packages 102, input/output devices 106, display devices 108, peripheral devices 110, and network devices 112. Memory system 104 provides stored instructions and data to processor packages 102, input/output devices 106, display devices 108, peripheral devices 110, and network devices 112. Examples of storage devices in memory system 104 include hard disk drives, random access memory (RAM), read only memory (ROM), flash memory drives and cards, and magnetic and optical disks.

Input/output devices 106 include any suitable type, number, and configuration of input/output devices configured to input instructions or data from a user to computer system 100 and output instructions or data from computer system 100 to the user. Examples of input/output devices 106 include a keyboard, a mouse, a touchpad, a touchscreen, buttons, dials, knobs, and switches.

Display devices 108 include any suitable type, number, and configuration of display devices configured to output textual and/or graphical information to a user of computer system 100. Examples of display devices 108 include a monitor, a display screen, and a projector.

Peripheral devices 110 include any suitable type, number, and configuration of peripheral devices configured to operate with one or more other components in computer system 100 to perform general or specific processing functions.

Network devices 112 include any suitable type, number, and configuration of network devices configured to allow computer system 100 to communicate across one or more networks (not shown). Network devices 112 may operate according to any suitable networking protocol and/or configuration to allow information to be transmitted by computer system 100 to a network or received by computer system 100 from a network.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method performed by a software transactional memory (STM) system in a computer system, the method comprising:
ensuring that a privatization artifact will not occur between a first transaction and a second transaction that is later than the first transaction in a completion order; and
allowing the second transaction to complete prior to the first transaction completing.

2. The method of claim 1 further comprising:
determining that the first transaction is not a damaging transaction to ensure that the privatization artifact will not occur.

3. The method of claim 1 further comprising:
determining that an intersection between a read set of the first transaction and a write set of the second transaction is an empty set to ensure that the privatization artifact will not occur.

4. The method of claim 1 further comprising:
determining that the first transaction accesses only transactional variables to ensure that the privatization artifact will not occur.

5. The method of claim 1 further comprising:
determining that a completion counter is equal to a completion number of the second transaction to ensure that the privatization artifact will not occur.

6. The method of claim 1 further comprising:
determining that the first transaction includes only pessimistic read and write accesses to ensure that the privatization artifact will not occur.

7. The method of claim 1 further comprising:
determining that the second transaction is not a privatizing transaction to ensure that the privatization artifact will not occur.

8. A method performed by a software transactional memory (STM) system in a computer system, the method comprising:
determining a first completion order of first and second transactions executed by a software transactional memory (STM) system; and
implementing a second completion order of the first and the second transactions that differs from the first completion order in response to determining that a privatization artifact will not occur between the first and the second transactions.

9. The method of claim 8 further comprising:
implementing the second completion order in response to determining that an intersection between a read set of the first transaction, which is earlier than the second transaction in the first completion order, and a write set of the second transaction is an empty set.

10. The method of claim 8 further comprising:
implementing the second completion order in response to determining that the first transaction, which is earlier than the second transaction in the first completion order, accesses only transactional variables.

11. The method of claim 8 further comprising:
implementing the second completion order in response to determining that a completion counter is equal to a completion number of the second transaction.

12. The method of claim 8 further comprising:
implementing the second completion order in response to determining that the first transaction, which is earlier than the second transaction in the first completion order, includes only pessimistic read and write accesses.

13. The method of claim 8 further comprising:
implementing the second completion order in response to determining that the second transaction, which is later than the first transaction in the first completion order, is not a privatizing transaction.

14. A computer readable storage medium storing computer-executable instructions that, when executed by a computer system, perform a method comprising:
ensuring that a privatization artifact will not occur between a first transaction and a second transaction that is later than the first transaction in a completion order; and
allowing the second transaction to complete prior to the first transaction completing.

15. The computer readable storage medium of claim 14, the method further comprising:
determining that the first transaction is not a damaging transaction to ensure that the privatization artifact will not occur.

16. The computer readable storage medium of claim 14, the method further comprising:
determining that a first intersection between a read set of the first transaction and a write set of the second transaction is an empty set to ensure that the privatization artifact will not occur.

17. The computer readable storage medium of claim 14, the method further comprising:
determining that the first transaction accesses only transactional variables to ensure that the privatization artifact will not occur.

18. The computer readable storage medium of claim 14, the method further comprising:
determining that a completion counter is equal to a completion number of the second transaction to ensure that the privatization artifact will not occur.

19. The computer readable storage medium of claim 14, the method further comprising:
determining that the first transaction includes only pessimistic read and write accesses to ensure that the privatization artifact will not occur

20. The computer readable storage medium of claim 14, the method further comprising:
determining that the second transaction has not been declared to be a privatizing transaction to ensure that the privatization artifact will not occur.
